(19) United States
(12) Patent Application Publication
(10) Pub. No.: US 2023/0011805 A1
(43) Pub. Date: Jan. 12, 2023

(54) Presence Availability Device and System

(71) Applicant: Star2Star Communications, LLC, Sarasota, FL (US)

(72) Inventors: Sergey Galchenko, Aurora, OH (US); Norman A. Worthington, III, Sarasota, FL (US)

(73) Assignee: Star2Star Communications, LLC, Sarasota, FL (US)

(21) Appl. No.: 17/367,806

(22) Filed: Jul. 6, 2021

(51) Int. Cl. H04L 29/08; G10L 15/22; G10L 15/18

(52) U.S. Cl. CPC H04L 67/24; G10L 15/22; G10L 15/1822; G01S 19/42

(57) ABSTRACT

The present invention relates to a presence availability discovery device comprising a series of computing devices, coupled via a network connector, to match connected worker(s) to a multimodal dialog initiated by an end user, comprising: a dialog identifier device, a context identifier device, a relevance classifier device, a connected worker identifier device, a connected worker router, a memory, and a controller. As a novel aspect, the connected worker identifier device parses a relevance discovery report created by the relevance classifier device to create a list of connected workers most responsive to the multimodal dialog and the end user, by correlating weighted intents against a list of connected workers, whereby the list of the one or more connected workers further comprises each of the one or more connected workers listed having an associated identifier, at least one availability marker, at least one skill, and at least one skill ranking.

### FIELD OF THE INVENTION

The present devices and systems generally relate to connecting one or more parties for communication in any one or more available modality based on an additional novel step of “availability” in an enhanced presence management device and system, with novel methodology.

### BACKGROUND OF THE INVENTION

A contact center, also generally referred to as a “customer interaction center” or an “e-contact center,” is a central point from which all individuals interact with one another across various channels, generally supporting the purpose of a given business enterprise. A contact center's primary purpose is to provide a business enterprise's customers with, by way of non-limiting example, technical support, customer service, and sales assistance.

A contact center typically includes one or more call centers (a dedicated physical office location set up to handle a large volume of phone calls) but may also include other types of customer contact, including emails, webchats, and social media interactions. Contact centers are often integrated into a business enterprise's customer relationship management strategy.

Contact centers are growing in importance as customers increasingly expect businesses to be consistently available on various channels, not just over the phone. The multichannel approach that contact centers may take allow them to create better customer experiences by refining customer service, increasing efficiency, and improving their insights into their customers' behaviors and needs.

Contact centers and call centers are both centers for customer service, and the two terms are often used interchangeably. However, the primary difference between the two is that call centers only manage inbound or outbound calls, while a contact center offers “omni-channel” or “multimodal” capabilities, including but not limited to, email, chat, voice over IP (VoIP) communication, and in some cases, website support.

While contact centers serve various functions, call centers specifically manage massive amounts of phone interactions, including controlling inbound calls and completing outbound calls. Similar to contact centers, call centers generally support customer service, technical support or sales interactions. However, they can also be used for telemarketing, information gathering, debt or payment collection and fraud prevention.

Contact centers also enhance customer profiling. Whenever customers interact with call or contact centers, they share information about their personal preferences and behavior, which is gathered and used to improve their customer experience during future interactions. Call center agents can collect some data through their calls, but the digital channels that contact centers use makes the process easier and more effective. Contact center software collects customer data from every channel used and compiles it into a single customer profile. Because most contact center customers interact using multiple channels, more data is gathered. This improves the contact center's ability to tailor the customer experience to benefit specific callers as well as better route their calls and other incoming communications.

As enhanced customer profiling becomes a more common and stable business requirement, as customers and employees of business enterprises continue to require more and more specific benefits from their communications, additional aspects of presence management need to be created. This present specification and associated claims describes one such novel device and systems for extending “presence management” to include “availability management,” as described in more detail, below. Furthermore, novel devices, systems, subsystems, and methods are needed to extend the concepts of presence management and the novel concept of availability management (described below) in all communications environments where collaboration is needed between working teams, departments, and the like, (i.e., all roughly representations of “connected workers”), essentially any communications environment where parties engage with one another, and with other internal and external parties in communication for the benefit of a business entity and its business model, products, or services.

### SUMMARY OF THE INVENTION

It is, therefore, an object of the present invention to provide a novel . . . device and system for evaluation using such device, independently and as part of such system.

The present invention may optionally operate within several communications and network environments, for example, but in no way limited to, the public Internet, a private Internet or Intranet, a network on one side of a third-party provided address family translation or network address translation (NAT) implementation, a network on a second side of a third-party provided NAT implementation, a data transport network or a series of networks, a communications network or series of networks, a non-optimized communications network or series of networks, an optimized communications network or series of networks, and the like.

In one exemplary embodiment, a presence availability discovery device is provided. This presence availability discovery device, in an exemplary aspect, can function to determine availability of one or more connected workers, via a series of computing devices coupled via a network connector, to match a one or more connected workers to a multimodal dialog initiated by an end user. The inventive presence availability discovery device further comprises a dialog identifier, a context identifier, a relevance classifier device, a connected worker identifier device, a connected worker router, a memory, and a controller.

In one exemplary aspect of the present device, the dialog identifier device can identify and assign an at least one identification to (1) the multimodal dialog and to (2) the end user by correlating the multimodal dialog among a list of modality types. The dialog identifier device can correlate the end user among a list of end user types, where the list of modality types and the list of end user types can be indexed in an identification database accessible to the dialog identifier device, via the network connector.

In another exemplary aspect of the present device, the context identifier device can assign an at least one context to (1) the multimodal dialog and to (2) the end user by correlating the multimodal dialog among a first list of contexts and correlating the end user among a second list of contexts. The first list of contexts and the second list of contexts can be indexed in a context database accessible to the context identifier device, via the network connector.

In a further exemplary aspect, the relevance classifier device can create a relevance discovery report based on the at least one identification and the at least one context by assigning a one or more weighted intents to (1) the at least one identification and to (2) the at least context based on correlating the at least one identification against a list of all supported identifications and correlating the at least one context against a list of all supported contexts. The list of all supported identifications and the list of all supported contexts can be indexed in a relevance database accessible to the relevance classifier device, via the network connector.

In yet still another exemplary aspect, the connected worker identifier device can parse the relevance discovery report to create a list of the one or more connected workers most responsive to (1) the multimodal dialog and to (2) the end user by correlating the one or more weighted intents against a list of the one or more connected workers indexed in a connected worker database accessible to the connected worker identifier device via the network connector. The list of the one or more connected workers can further comprise each of the one or more connected workers listed having (1) an associated identifier, (2) an at least one availability marker, (3) an at least one skill, and (4) an at least one skill ranking. The list of the one or more connected workers most responsive to the multimodal dialog can be prioritized by (1) the at least one availability marker, (2) the at least one skill, and (3) the at least one skill ranking;

In another exemplary aspect, the connected worker router can interpret the list of the one or more connected workers most responsive to the multimodal dialog. The connected worker router can direct the at least one multimodal dialog to the one or more connected workers in a prioritized order.

In an additional exemplary aspect, the memory can be coupled to the dialog identifier device, the context identifier device, the relevance classifier device, the connected worker identifier device, and the connected worker router device via the network connector. The memory can store and couple the identification database, the context database, the relevance database, and the connected worker database.

In yet still another exemplary aspect, the controller can comprise an operating system. The operating system can direct and control the operation and function of the dialog identifier device, the context identifier device, the relevance classifier device, the connected worker identifier device, the connected worker router device, and an input/output module. The input/output module can provide basic control and input/output operations to the presence availability discovery device via the network connector.

The following are either or both additional and exemplary aspects of the present exemplary embodiment, one or more of which can be combined with the basic inventive device embodied above:
the list of modality types can comprise voice, chat, short messaging, multimedia messaging, video, document sharing, form submissions, and review form;
the list of end user types can comprise human and artificial intelligence, as end user types;
the list of end user types can comprise human, artificial intelligence, a job title, and an at least one skill, as end user types;
the list of content types of multimodal dialogs can comprise an at least one metadata associated with the content types of multimodal dialogs;
the one or more weighted intents can comprise at least one matrix of intents weighted based on use of at least one keyboard within a content of the at least one multimodal dialog;
the at least one availability marker can be manually activated by the one or more connected worker, and can comprise: “available,” “not available,” and “do not disturb except for whitelist;”
an availability channel monitor which can monitor the one or more connected workers presence within a set of communication channels and can select the at least one availability marker listed in the list of the one or more connected workers based on the one or more connected workers presence within the set of communication channels;
the at least one availability marker can be determined based on activation of a sensor within an object associated with the one or more connected workers;
the at least one availability marker can be determined based on a geolocation activation within a satellite-based radio navigation system;
the at least one skill can be determined dynamically based on an artificial intelligence system which monitors the at least one dialog parsing its content and can assign the at least one skill to the at least one connected workers based on the parsing;
the at least one skill ranking can be determined dynamically based on an artificial intelligence system which monitors the at least one dialog and parsing its content and can assign the at least one skill ranking to the at least one connected workers based on the parsing;
the list of the one or more connected workers most responsive to the multimodal dialog can be prioritized with the highest priority weight given to the at least one availability marker; and
the connected worker router can direct the at least one multimodal dialog to the one or more connected workers with the highest priority weight given to the at least one availability marker.

In another exemplary embodiment, a system is provided. The system comprises at least one end user, at least one connected worker, an at least one network, and a presence availability discovery device. The presence availability discovery device comprises a series of computing devices coupled via a network connector to the network to match the at least one connected worker to an at least one multimodal dialog initiated by the at least one end user.

These and other exemplary aspects of the present basic inventive concept are described below. Those skilled in the art will recognize still other aspects of the present invention upon reading the included detailed description.

### DETAILED DESCRIPTION OF THE DRAWINGS

The present invention is illustrated by way of example, and not limitation, in the figures depicted in the following drawings.

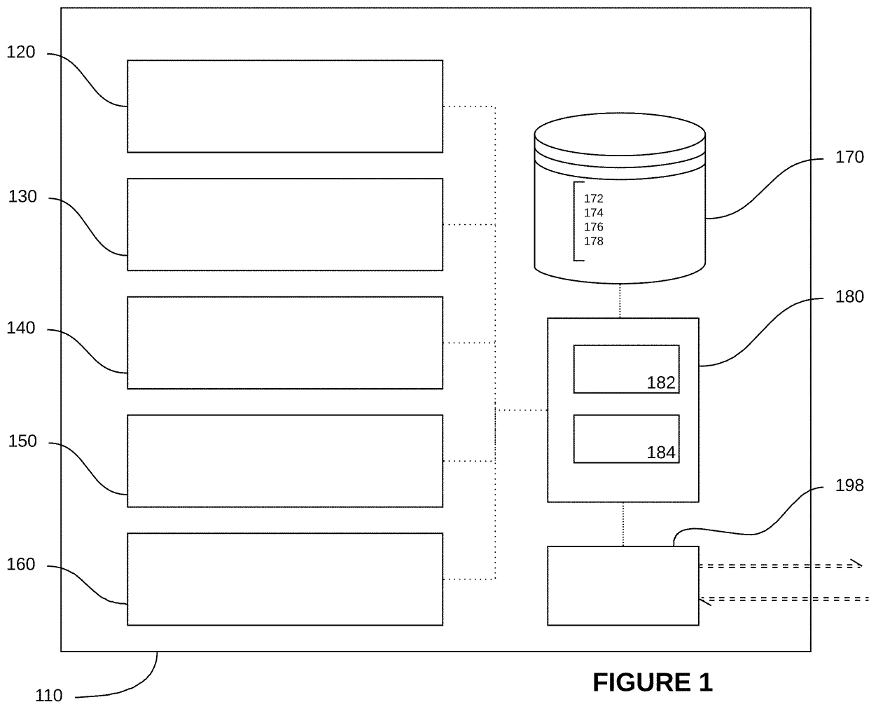

FIG. 1 illustrates an exemplary embodiment of the present invention, a presence availability discovery device.

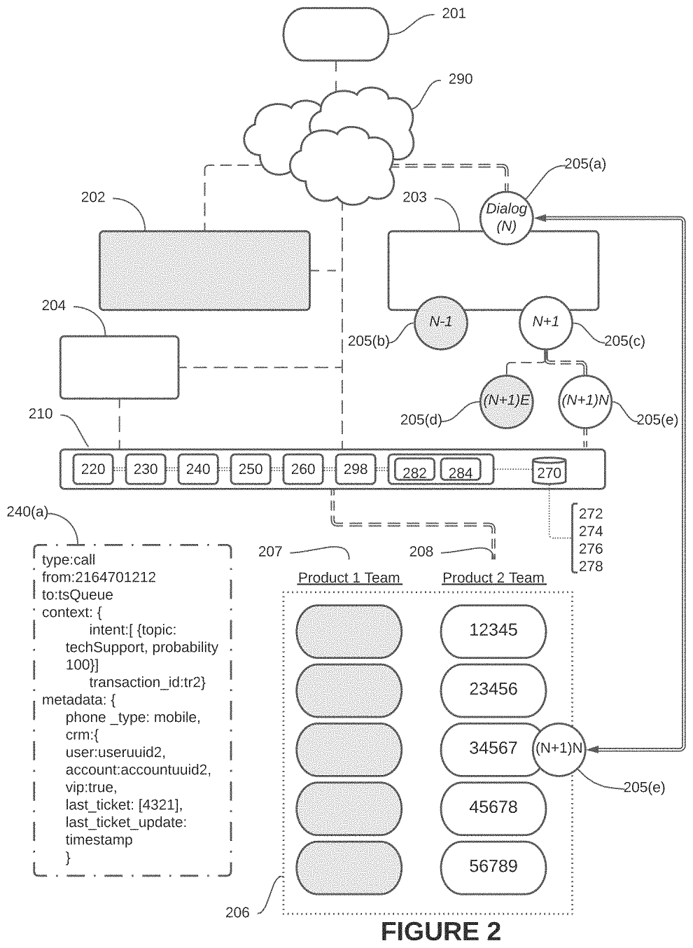

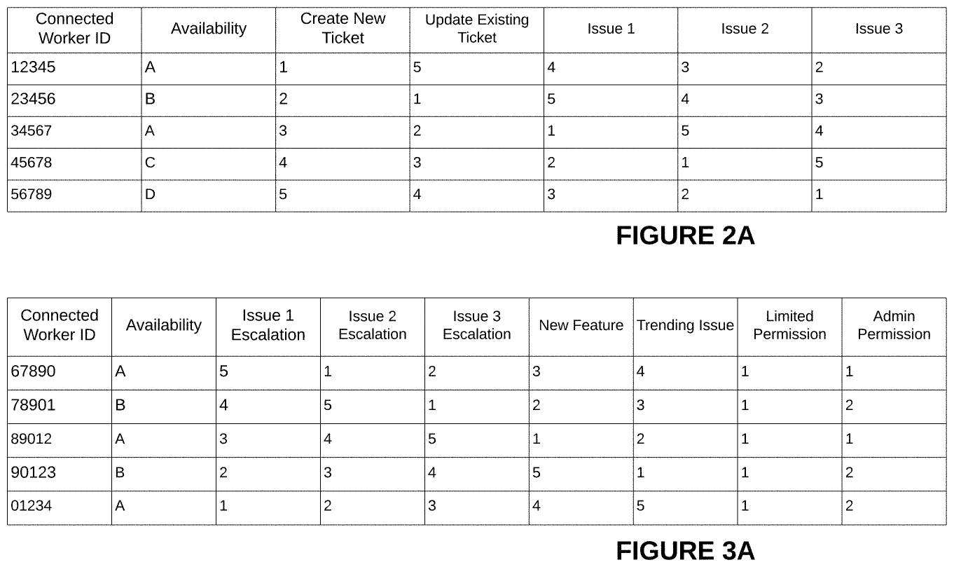

FIG. 2 illustrates one exemplary representation of a preferred system in which a presence availability discovery device is configured as part of an external-facing customer support environment.

FIG. 2A depicts one exemplary matrix illustrating an exemplary list of one or more connected workers indexed in a connected worker database accessible to a novel connected worker identifier device, one novel element of the present invention.

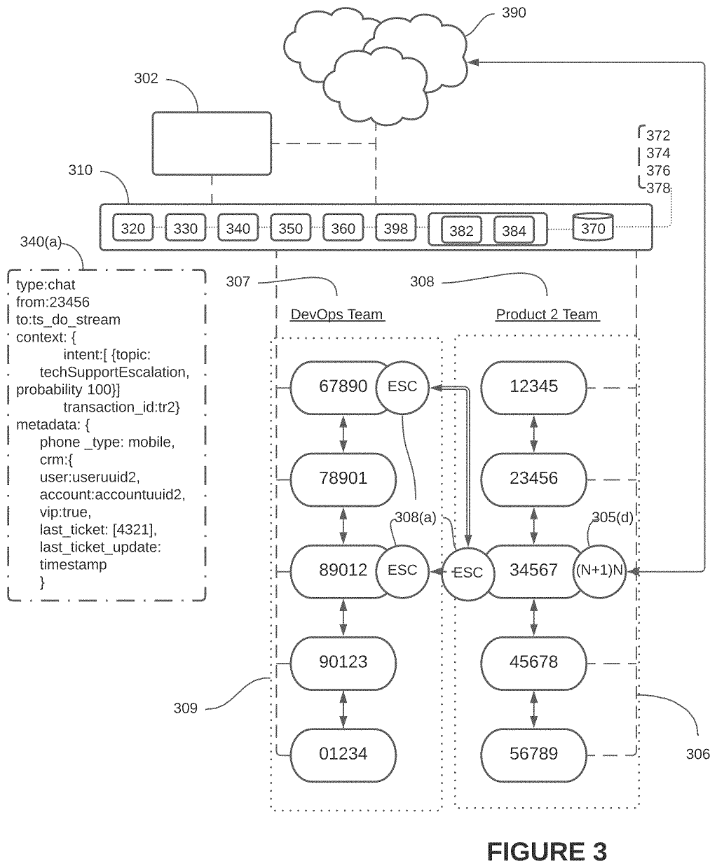

FIG. 3 illustrates another exemplary representation of a preferred system in which a presence availability discovery device is configured as part of an internal-facing DevOps escalation environment.

FIG. 3A depicts a second exemplary matrix illustrating an exemplary list of one or more connected workers indexed in a connected worker database accessible to a novel connected worker identifier device, one novel element of the present invention.

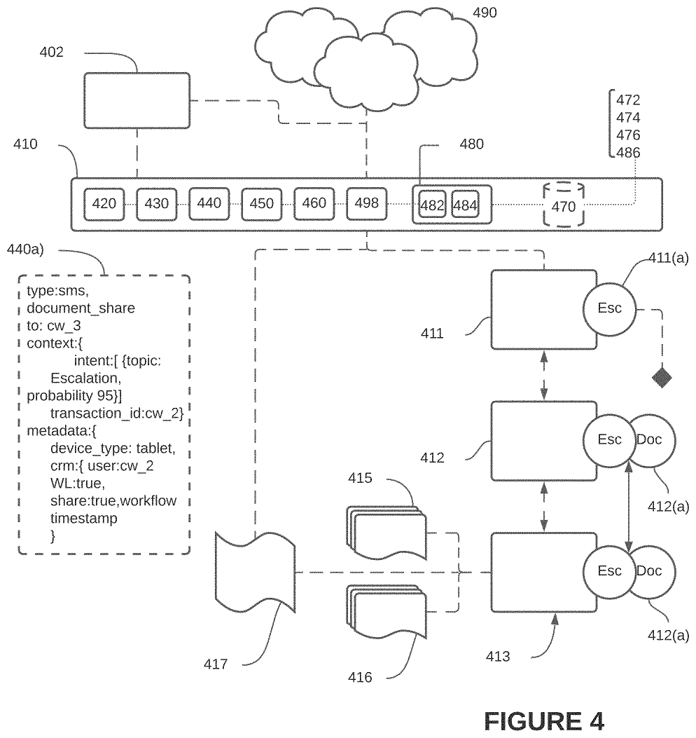

FIG. 4 illustrates another exemplary representation of a preferred system in which a presence availability discovery device is configured based on an at least one connected worker having a black list, a white list, and/or a sensor component for assessing availability.

### DETAILED DESCRIPTION OF THE INVENTION

The present invention will now be described more fully herein with reference to the accompanying drawings, which form a part of, and which show, by way of illustration, specific exemplary embodiments through which the invention may be practiced. This invention may, however, be embodied in many different forms and should not be construed as limited to the exemplary embodiments and preferred representations set forth below. Rather, these exemplary embodiments and preferred representations are provided so that this disclosure will be thorough and complete, and will fully convey the scope of the invention to those skilled in the art. Among other things, the present invention may be embodied as devices, systems, and methods. Accordingly, various exemplary embodiments may take the form of entirely hardware embodiments, entirely software embodiments, and embodiments combining software and hardware aspects. The following detailed description is, therefore, not to be taken in a limiting sense.

In the present field of its invention, this invention generally relates to an enhanced and novel element of a presence management system, which is applicable in and extends to all business environments, instead of being limited to particularly call center and contact center environments. Particularly, the novel devices, systems, and subsystems described herein may be configured and put to use in an communications environment where collaboration, working teams, departments, and the like (i.e., all roughly representations of “connected workers”), engage with one another and with other internal and external parties in communication for the benefit of the business entity and its business model, products, or services. As contemplated throughout this specification and the associated claims, the present invention is highly configurable, and capable of application in all networked environments where communication control is desirable. Generally, in computing and communications networks, configuration refers to an arrangement of systems (i.e., computing and communications systems) of functional units based on nature, number, characteristics, and the like, and can include any combination of hardware computing units and software computing units, as considered by those skilled in the art. Configuration affects both the function and performance of computing and communications systems, however a device or system which is highly configurable, in the form and function in which the presently described inventive concept is, configuration in this exemplar minimizes system lag time, increases connectivity and efficiency, and overall promotes a better communication interaction experience for the parties involved.

Throughout this specification and claims, the following terms take the meanings explicitly associated herein, unless the context dictates otherwise. The phrases “in one embodiment” and “this exemplary embodiment” do not necessarily refer to the same embodiment, though they may. Furthermore, the phrases “in another embodiment,” “additional embodiments,” and “further embodiments” do not necessarily refer each or collectively to a different embodiment, although they may. As described below, various embodiments of the invention may be readily combined, without departing from the scope or spirit of the invention.

Also, throughout this specification, the following terms and phrases are dispensed with, unless the context dictates others. The phrases “at least one of,” “one or more,” “one of,” “more than one,” and “a plurality of” as those phrases are commonly interpreted as a part of the written description interpretation and claim construction guidelines as stated in the Manual of Patent Examining Procedure in Section 2163, as written herein, should not be considered limiting or inclusive. Their collective meaning should encompass the various definitions embodied by each, collectively, meaning a reference to a single element or a plurality of elements comprises, “at least one of,” “one or more,” “one of,” “more than one,” and “a plurality of.”

Also, the term “or” is an inclusive “or” operator and is equivalent to the term “and/or” unless the context dictates otherwise. The term “based on” is not exclusive and allows for being based on additional factors not described, unless the context dictates otherwise. In addition, throughout the specification, the meaning of “a,” “an,” and “the” include plural references. The meaning of “in” includes “in” and “on.”

FIG. 1 briefly describes one exemplary embodiment of a not yet configured presence availability discovery device, to provide a basic understanding of some aspects of the invention. This brief description provided alongside the illustration in FIG. 1 is not intended as an extensive overview, nor is it intended to identify key or critical elements, to delineate, or otherwise narrow the scope. Its purpose is to present concepts in a simplified form as a prelude to a more detailed description, which is presented later. The present invention, generally, is directed towards a novel definition and application of “availability.”

The presence availability discovery device 110, as illustrated in FIG. 1, is a generic discovery mechanism for matching parties trying to communicate with one another (either in a single directional flow or a multidirectional flow), in the context of a business interaction.

Presence availability discovery device 110 comprises a series of computing devices, coupled via a network connector 198, to match connected worker(s) to a multimodal dialog initiated by an end user, comprising: a dialog identifier device 120, a context identifier device 130, a relevance classifier device 140, a connected worker identifier device 150, a connected worker router 160, a memory 170, and a controller 180.

Connected workers are any worker who is integrated into their work environment by connective technologies. Most professions have a suite of software tools that help them work better. Connected worker technologies, however, go further than software. Connective technologies actively exchange data with other devices and machines in a work system. With both hardware and software components, connective technologies, including the novel concept embodied by the inventive concept herein, contextualize worker's action within a broader system in real-time. The supportive role that connected worker technologies play means that workers can do more. This is why the phrase “connected worker” is often used interchangeably with “augmented worker.”

Dialog identifier device 120 identifies and assigns an at least one identification to (1) the multimodal dialog and to (2) the end user by correlating the multimodal dialog among a list of modality types and correlating the end user among a list of end user types, wherein the list of modality types and the list of end user types are indexed in an identification database 172 accessible to dialog identifier device 120 via network connector 198.

An at least one identification can be defined as an identity; a value assigned. Dialog identifier device 120 is a computational device which functions to assign a value of either modal human or artificial intelligence and what type of modality is associated with the user, one of: phone, chat, SMS/MMS, video, document sharing, form submissions, review form, and the like. The at least one identification values can be static, dynamic and/or algorithmically based on the fly, set by an administrator, AI, and/or any combination of administrator and AI that is beneficial to the business entity.

A multimodal dialog is a series of contextual interactions with at least one contextual purpose. In its most basic sense, multimodality is a theory of communication and social semiotics. Multimodality describes communication practices in terms of the textual, aural, linguistic, spatial, and visual resources—or modes—used to compose messages. Where various media components are concerned, multimodality is the use of several modes (media) to create a single artifact. The collection of these modes, or elements, contributes to how multimodality affects different rhetorical situations, or opportunities for increasing an audience's reception of an idea or concept. Everything from the placement of images to the organization of the content creates meaning. This is the result of a shift from isolated text being relied on as the primary source of communication, to the image being utilized more frequently in the digital age. While multimodality as an area of academic study did not gain traction until the twentieth century, all communication, literacy, and composing practices are and always have been multimodal.

The second group of multimodal systems presents users with multimedia displays and multimodal output, primarily in the form of visual and auditory cues. Interface designers have also started to make use of other modalities, such as touch and olfaction. Proposed benefits of multimodal output system include synergy and redundancy. The information that is presented via several modalities is merged and refers to various aspects of the same process. The use of several modalities for processing exactly the same information provides an increased bandwidth of information transfer. Currently, multimodal output is used mainly for improving the mapping between communication medium and content and to support attention management in data-rich environment where operators face considerable visual attention demands.

An end user can be defined as the one or more parties initiating a dialog. End users can be human (A bipedal primate mammal; a person) who initiates the dialog via a human accessible interface device or artificial intelligence (AI) (a machine capable of imitating intelligent human behavior) which initiates the dialog via an electronic interface device (a UI operated by an artificial intelligence).

The list of modality types may include, but is not limited to phone, chat, SMS/MMS, video, document sharing, form submissions, review form, and the like. Additional embodiments are contemplated where more than one modality may be in use for a single dialog, by way of non-limiting example, video and document sharing, and the like.

Generally, the list of end user types human/phone, human/chat, human/SMS/MMS, human/video, human/document sharing, human/form submission, human/review form, AI/autodial or other automated phone, AI/chat, AI/SMS/MMS, AI/document sharing, AI/form submission, and the like.

Identification database 172 is defined as a database where identifications are maintained, and can be any type of database which is functionally operable for a business entity. Generally, a database is an organized collection of data, generally stored and accessed electronically from a computer system. Where databases are more complex they are often developed using formal design and modeling techniques.

Additional embodiments are contemplated where memory 170 further includes a form of database management system (DBMS), or software that interacts with applications, and the database itself to capture and analyze the data. The DBMS software additionally encompasses the core facilities provided to administer the database. The sum total of the database, the DBMS and the associated applications can be referred to as a “database system”. Often the term “database” is also used to loosely refer to any of the DBMS, the database system or an application associated with the database.

One way to classify databases involves the type of their contents, for example: bibliographic, document-text, statistical, or multimedia objects. Another way is by their application area, for example: accounting, music compositions, movies, banking, manufacturing, or insurance. A third way is by some technical aspect, such as the database structure or interface type. This section lists a few of the adjectives used to characterize different kinds of databases. An in-memory database is a database that primarily resides in main memory, but is typically backed-up by non-volatile computer data storage. Main memory databases are faster than disk databases, and are often used where response time is critical, such as in telecommunications network equipment.

Network connector 198 is a device that terminates a segment of cabling or provides a point of entry for networking devices, such as, for example, computers, hubs, and routers, to presence availability discovery device 110.

Context identifier device 130 assigns an at least one context to (1) the multimodal dialog and to (2) the end user by correlating the multimodal dialog among a first list of contexts and correlating the end user among a second list of contexts, wherein the first list of contexts and the second list of contexts are indexed in a context database 174 accessible to context identifier device 130 via network connector 198.

Context identifier device 130 is a computational device element which functions to assign a context value, based on a comparison of context types associated with multimodal dialogs content and context types associated with end user types. Contexts can be any one or more of the reasons that a user may contact the entity employing the connected workers The values can be static, dynamic and/or algorithmically based on the fly, set by an administrator, AI, and/or any combination of administrator and AI that is beneficial to the entity using the device.

The first list of contexts and the second list of contexts contain context values which comprise any one or more of any of the supported purposes that an end user may contact the business entity or any of the connected workers directly, including any reasoning purposed upon any of the various modality components.

Context database 174 is a database where contexts are maintained, and can be any type of database, embedded, maintained separately, or the like, as described above.

Relevance classifier device 140 creates a relevance discovery report based on the at least one identification and the at least one context by assigning a one or more weighted intents to (1) the at least one identification and to (2) the at least context based on correlating the at least one identification against a list of all supported identifications and correlating the at least one context against a list of all supported contexts, wherein the list of all supported identifications and the list of all supported contexts are indexed in a relevance database 176 accessible to relevance classifier device 140 via network connector 198;

Relevance classifier device 140 is a computational device element which functions to assign a value based on the type of identification value and the type of context value previously assigned to the dialog, determining if the dialog is “relevant” to the entity and should be responded to by a responsive connected worker. The relevance discovery report, as discussed in more detail in reference to FIG. 2, comprises a report of intent relevance values, generally defined as the one or more of any of the supported intents or purposes that a user may contact the entity employing the connected worker—this can be modified based on the available connected workers during any given period, static, dynamically updated, and the like. A relevance discovery report can be a single value or a matrix of values.

The one or more weighted intents can be defined as a passive data structure holding an abstract description of an action to be performed., this allows for each type of task (activity) to be handled by the connected worker best suited to it, even if provided to an outside third party.

The list of all supported identifications and list of all supported contexts comprises the different types of reasons that an end user would be initiating a dialog to the entity, with different priorities and weight based on entity factors.

Relevance database 176 is generally defined as a database where contexts are maintained, and can be any type of database, embedded, maintained separately, or the like, as described above.

Connected worker identifier device 150 parses the relevance discovery report to create a list of the one or more connected workers most responsive to (1) the multimodal dialog and to (2) the end user by correlating the one or more weighted intents against a list of the one or more connected workers indexed in a connected worker database 178 accessible to connected worker identifier device 150 via network connector 198, whereby the list of the one or more connected workers further comprises each of the one or more connected workers listed having (1) an associated identifier, (2) an at least one availability marker, (3) an at least one skill, and (4) an at least one skill ranking, whereby the list of the one or more connected workers most responsive to the multimodal dialog is prioritized by (1) the at least one availability marker, (2) the at least one skill, and (3) the at least one skill ranking.

Connected worker identifier 150 is a computational device element which functions to parse (break apart the various assigned values and extract the weighted intents assigned to the identification and the context), analyzing how best a task is accomplished, including manual and automated activities, task and element durations, task frequency, task allocation, task complexity, environmental conditions, and any other unique factors involved in or required for one or more connected workers to perform a given task.

The list of the one or more connected workers generally comprises all available connected workers at an entity, however, this list may be segmented or categorized by department, or some other categorization methodology. This list can be static, updated dynamically, or the like. Additional embodiments are contemplated where this list is updated based on the one or more availability markers of any or all of the connected workers who may be listed. List of the one or more connected workers most responsive to the multimodal dialog and to the end user is a limited list of connected workers who, based on the parsed relevance discovery report, have (1) availability marker (2) skill and (3) skill ranking prioritized based on the weighted intents assigned in the relevance discovery report.

An associated identifier is a unique token or tokens, character sequences, alphanumeric sequences, and the like, used to identify a connected worker.

The at least one availability marker is a unique token or tokens, character sequences, alphanumeric sequences, and the like, used to identify an “availability” status of a connected worker. Availability in computer science generally means the ability of an end user to access resources in a specified location and in the correct format. This concept is extended here and this is the novel aspect, that “availability” is determined either actively or passively by the connected worker and/or the connected worker's surroundings. Traditionally, “presence” has been limited to one channel, for example: on phone—not available, not on phone—available, engaged in SMS/chat—not available, not engaged—available, on video—not available, not on video—not available, and the like. Extending the concept of presence to availability herein, the designation may include at least one or one or more available modalities and statuses, by way of example and not in limitation, on phone—not available for phone, but available for SMS, MMS, chat, or video. Additional embodiments are contemplated where determination of the availability marker can be either or both automated (for example, through collection of data through active and passive network monitors, sensors, and the like) and manual, as determined by the connected worker, by way of example, a connected worker manually selecting a “do not disturb” feature, which will mark the connected worker as not available until inactivated.

The at least one skill can be defined as a learned ability to perform an action with determined results with good execution often within a given amount of time, energy, or both. Skills can often be divided into domain-general and domain-specific skills. For example, in the domain of work, some general skills would include time management, teamwork and leadership, self-motivation and others, whereas domain-specific skills would be used only for a certain job. Skill usually requires certain environmental stimuli and situations to assess the level of skill being shown and used. Skills based routing, for example, uses a predetermined list of skills and is a call assignment strategy used in call centers to assign incoming calls to the most suitable agent, instead of simply choosing the next available agent. The value of skills can be set by the entity, based on the connected workers available, and the like. Skills can be configured to be limited to predetermined sets of skills, or in additional exemplary embodiments the skills may be dynamically set by a system administrator, determined on the fly by network monitoring components, or the like.

The at least one skill ranking is the weighted value assigned to a certain skill for a certain connected worker which can be based on expertise in a certain skill, or the like. Skill ranking can be configured to be limited to predetermined sets of skills rankings, or in additional exemplary embodiments the skill rankings may be dynamically set by a system administrator, determined on the fly by network monitoring components, or the like.

Connected worker router 160 interprets the list of the one or more connected workers most responsive to the multimodal dialog and the connected worker router directs the at least one multimodal dialog to the one or more connected workers in a prioritized order. Connected worker router 160 is a networking device that performs data traffic directing functions, specifically prioritized delivery of dialogs, as discussed in more detail in reference to FIGS. 3 and 4.

Memory 170 is coupled to dialog identifier device 120, context identifier device 130, relevance classifier device 140, connected worker identifier device 150, and connected worker router device 160 via network connector 198, wherein memory 170 stores and couples identification database 172, context database 174, relevance database 176, and connected worker database 178.

Memory 170 is a device or system that is used to store information for immediate use in a computer or related computer hardware and digital electronic devices. Examples of non-volatile are flash memory and ROM, PROM, EPROM and EEPROM memory. Examples of volatile memory are primary storage, which is typically dynamic random-access memory (DRAM), and fast CPU cache memory, which is typically static random-access memory (SRAM) that is fast but energy-consuming, offering lower memory areal density than DRAM.

Coupling is the degree of interdependence between software and hardware components, oftentimes a measure of how closely connected two routines or modules are, otherwise described as the strength of the relationships between modules. It is contemplated that controller 180 offers either or both high coupling and low coupling capabilities to the device components of presence availability discovery device 110. Coupling is usually contrasted with cohesion. Low coupling often correlates with high cohesion, and vice versa. Low coupling is often thought to be a sign of a well-structured computer system and a good design, and when combined with high cohesion, supports the general goals of high readability and maintainability.

Controller 180 further comprises operating system 182, which directs and controls the operation and function of dialog identifier device 120, context identifier device 130, relevance classifier device 140, connected worker identifier device 150, connected worker router device 160, memory 170, and network connector 198. Controller 180 further comprises an input/output module 184 which provides basic control and input/output operations to presence availability discovery device 110 via network connector 198.

In computing and especially in computer hardware, a controller, such as, for example, controller 180, is a chip, an expansion card, or a stand-alone device that interfaces with a peripheral device. This may be a link between two parts of a computer (for example a memory controller that manages access to memory for the computer) or a controller on an external device that manages the operation of (and connection with) that device. The term is sometimes used in the opposite sense to refer to a device by which the user controls the operation of the computer, as in game controller. In desktop computers the controller may be a plug in board, a single integrated circuit on the motherboard, or an external device. In mainframes the controller is usually either a separate device attached to a channel or integrated into the peripheral.

Operating system 182, or central processing unit (CPU), is the electronic circuitry within a computing device that carries out the instructions of a computer program by performing the basic arithmetic, logical, control and input/output (I/O) operations specified by the instructions. The instructions to be executed are generally kept in some kind of memory, and as illustrated in this FIG. 1, memory 170.

Input/output module (and the corresponding input/output operations) are the device pieces of hardware used by a human (or other system) to communicate with a computer, and in this FIG. 1, the hardware pieces used to communicate with presence availability discovery device 110. For instance, a keyboard or computer mouse is an input device for a computer, while monitors and printers are output devices. Devices for communication between computers, such as modems and network cards, typically perform both input and output operations.

The designation of a device as either input or output depends on perspective. Mouse and keyboards take physical movements that the human user outputs and convert them into input signals that a computer can understand; the output from these devices is the computer's input. Similarly, printers and monitors take signals that a computer outputs as input, and they convert these signals into a representation that human users can understand. From the human user's perspective, the process of reading or seeing these representations is receiving input; this type of interaction between computers and humans is studied in the field of human-computer interaction.

In computer architecture, the combination of the CPU and main memory (as illustrated in FIG. 1, operating system 182 and memory 170), to which the CPU can read or write directly using individual instructions, is considered the brain of a computer. Any transfer of information to or from the CPU/memory combo, for example by reading data from a disk drive, is considered I/O. The CPU and its supporting circuitry may provide memory-mapped I/O that is used in low-level computer programming, such as in the implementation of device drivers, or may provide access to I/O channels. An I/O algorithm is one designed to exploit locality and perform efficiently when exchanging data with a secondary storage device, such as a disk drive.

An I/O interface is required whenever the I/O device is driven by a processor. Typically a CPU communicates with devices via a bus. The interface must have necessary logic to interpret the device address generated by the processor. Handshaking should be implemented by the interface using appropriate commands (like BUSY, READY, and WAIT), and the processor can communicate with an I/O device through the interface. If different data formats are being exchanged, the interface must be able to convert serial data to parallel form and vice versa. Because it would be a waste for a processor to be idle while it waits for data from an input device there must be provision for generating “interrupts” and their corresponding “type numbers,” for further processing by the processor if required.

A computer that uses memory-mapped I/O accesses hardware by reading and writing to specific memory locations, using the same assembly language instructions that a computer would normally use to access memory. An alternative method is via instruction-based I/O which requires that a CPU have practiced instructions for I/O. Both input and output devices have a data processing rate that can vary greatly. With some devices able to exchange data at very high speeds direct access to memory (DMA) without the continuous aid of a CPU is required.

As noted above, the written description thus far has described presence availability discovery device 110, as illustrated in FIG. 1, as a generic discovery mechanism for matching parties trying to communicate with one another (either in a single directional flow or a multidirectional flow), in the context of a business interaction, without reference to its highly configurable nature or the types of identifications, contexts, and weighted intents which may factor into its usage and subsequent output, let alone the various elements of availability which, based upon configuration, alter the complete operability and function of presence 110.

In a functionally operable state, presence availability discovery device 110 first identifies the relevant parties to the interaction. To do so, presence availability discovery device 110 first determines the party initiating the interaction, which for sake of simplicity would be either a human or an inbound/outbound initiation by an electronic interface or artificial intelligence (AI). The initiated interactions, in this context, occur in all forms of communications methods using “voice” solutions (which voice solutions can be traditional voice services such as a phone call, but also other communication modalities such as chat, short messaging, multimedia messaging, video, document sharing, form submissions, and review forms), essentially all communications coming into a business entity that are not face-to-face interactions. These interactions are described herein are defined as a “dialog” or “multimodal dialog”—interaction of one or more parties using a modality. As contemplated throughout this specification and the claims, dialogs are human to human, human to AI, or AI to human, using any singular or combination of the voice solutions defined above.

In determining the party initiating the interaction, presence availability discovery device 110 activates dialog identifier device 120 upon receiving a flag or other notification that a multimodal dialog has been initiated via one or more of its incoming communications channels. Dialog identifier device 120 identifies and assigns a singular identification, or in additional embodiments, an at least one identification or a one or more identifications, to both the dialog and to the end user (i.e., an identification that identifies the modality of the dialog and the end user who initiated it, as described above), by correlating the multimodal dialog against a list of modality types and correlating the end user against a list of end user types. In practical application, at a business entity, the entity determines what types of modalities the business entity accepts and what types of end users the entity will accept dialogs from. Generally, business entities have predetermined set of types, most commonly based on the types of products, services, and subscriptions that the entity has available to it and how those products, services, and subscriptions configured for use within the business entity. Presence availability discovery device 110, at dialog identifier device 120, can in exemplary embodiments, be configured to be limited to predetermined sets of modality and end user types contained in identification database 172, or in additional exemplary embodiments, the types may be dynamically set by a system administrator, determined on the fly by network monitoring components, or the like.

Presence availability discovery device 110 activates context identifier 130 once an identification, an at least one identification, or a one or more identifications are assigned to the multimodal dialog and end user. Context identifier 130 then assigns a context, or in additional embodiments, an at least one context or a one or more contexts, to the multimodal dialog and to the end user (i.e., a purpose of the dialog based on the dialog and the end user, as more fully described above), by correlating the dialog against a first list of contexts or purposes based on the modality identified in association with the dialog and by correlating the end user against a second list of contexts or purposes based on the type of end user identified. Generally, business entities have predetermined sets of contexts, most commonly based on the industry the business entity is in. Presence availability discovery device 110, at context identifier device 130, can in exemplary embodiments, be configured to be limited to predetermined sets of contexts contained in the context database, or in additional exemplary embodiments the contexts may be dynamically set by a system administrator, determined on the fly by network monitoring components, or the like.

Using the identification and context of the initiated multimodal dialog, presence availability discovery device 110 creates a “discovery” of the party initiating the interaction. Having this information relating the party initiating the interaction further assists presence availability discovery device 110 to identify at least one connected worker within the business entity who is the most responsive to the dialog.

How presence availability discovery device 110 identifies the at least one connected worker within the business entity who is the most responsive to a multimodal dialog is dependent on many individualized, programmable, and scalable factors which are business entity specific. Also as previously discussed, presence availability discovery device 110, as a novel inventive concept, is comprehensively configurable based on the needs of a specific entity requiring a discovery mechanism for matching parties in the context of interactions with the business entity. As such, the following three exemplary embodiments and their associated figures (FIG. 2 through FIG. 4) are provided to illustrate three exemplary environments and associated representations in which dialog identifier device 120 and context identifier device 130, in relation to additional embodiments of the other elements as described above (specifically, relevance classifier device 140, connected worker identifier device 150, and connected worker router 160, as respectively renumbered) can be individualized, programmed, and scaled for certain business entity specific environments.

FIG. 2 illustrates one exemplary representation of a preferred system in which a presence availability discovery device is configured as part of an external-facing customer support environment.

In a business entity that provides end users with technology products and services, these entities generally have a technical support environment 206 (which for ease of illustration here, contains two dedicated teams Product 1 Team 207 and Product 2 Team 208), which an initiating end user 201 generally contacts this technical support environment 220 specifically to communicate directly with a responsive party who is able to help regarding specific problems with a product or service (as opposed to receiving training, provisioning and/or customization of the products or service) offered by the business entity. For simplicity and ease of description of the novel aspects of the implementation of presence availability discovery device 210 in this embodiment, implementation of presence availability discovery device 210 will be described herein with reference to a traditional technical support model.

In a traditional technical support model, an initiating end user 201 (as described above, human or AI) contacts technical support environment 206 directly, via any available modality that the business entity offers, by way of most common example but not in limitation, voice call, chat, SMS/MMS, and form submission. Often times, an initiating end user caller is directed to a specific “call queue” which has some form of interactive voice response (IVR) technology associated with it which allows interaction with a computer-operated phone system, or in additional embodiments, other communication systems, through use of voice and dual-tone multi-frequency signaling (DTMF) tones input via a set of virtual or physical buttons, a toggle, a keypad, a keyboard, or the like. Queues, such as, in one example, support call queue 203, are sometimes connected to IVR technology, where upon initiation of a communication, for example, dialog 205(a) by end user 201, the IVR technology, with its list of predetermined options, grants business entities initially a high-level context or purpose of dialog 205(a), i.e., to receive technical support. Other queues, for example, support email queue 202, are available, for modality types such as form submission which require input from an end user 201 to complete the information collection. In traditional technical support environments, this is often the stopping point of information collected and identification made on what the initiated dialog pertains to and who is contacting the business entity. Callers are generally connected to the next available “agent” (which, in the context of a technical support environment, may be either human or AI) available within the technical support department.

One example of how presence availability discovery device 210 may be configured in technical support environment 206 is provided herein. This exemplary embodiment is offered no way in limitation, but for illustrative purpose only. As used within this exemplary embodiment, the business entity contemplated offers two software services on a subscription basis, which customers have access to. Customers sometimes allow other users to use their subscribed software services. The business entity has a support email address, with support email queue 202 configured, and a support telephone number with support call queue 203 configured. When end user 201 calls (for ease of illustration, this “call” is represented as 205(a)) into support queue 203, end user 201 has the option to select either of the two services, which queue decision tree options are represented as 205(b) and 205(c), for simplicity. From there, end user 201 has the option to either “create a new ticket” (represented here as 205(d), for simplicity) or “update/add to an existing ticket” (represented here as 205(e), for simplicity). When end user 201 emails the support email queue 202, a confirmation email is automatically sent with a short form questionnaire asking for customer account information, which service support is requested for, and whether or not the end user wants to “create a new ticket” or “update/add to an existing ticket.”

Where presence availability discovery device 210 is implemented in this exemplary environment, upon receiving the flag or notification that dialog 205(a) has been initiated by end user 201, dialog identifier device 220 assigns an identification, which could be any one of the following, based on the multimodal dialog 205(a) and end user 202: voice call/human, form submission/human, voice call/AI, or form submission/AI. Furthermore, a context assigned by the context identifier device 230 would optimally be any one or more of any of the supported purposes that end user 201 may contact the business entity, but for ease of description in this preferred embodiment, the context would be either “receive technical support” or “other” (e.g., for those cases where the initiating end user did not intend to contact the specific queue and needs to be routed elsewhere within the business entity).

Once an identification is assigned by dialog identifier device 220 and a context is assigned by context identifier device 230, relevance classifier device 240 creates a relevance discovery report 240(a). This relevance discovery report 240(a) is formulated by relevance classifier device 240 assigning one or more weighted intents to the identification and to the context.

Generally, relevance classifier device 240 correlates the identification against a list of all supported identifications and correlates the context against a list of all supported contexts to create the report, with the weighted intent “relevance values” being one or more of any of the supported intents or purposes that an end user may contact the business entity. The relevance discovery report 240(a) can include single values or at least one, or one or more matrices of values, depending on any known configuration requirements. A weighted intent, as a novel aspect of the presence availability discovery device, is a passive data structure holding an abstract description of an action to be performed, allowing for each type of task (activity) to be further classified and informed by the connected worker best suited to it, even if provided to an outside third party. In this exemplary embodiment, the relevance values may be modified based on the available connected workers during any given period, a static list maintained by a system administrator, dynamically updated with a predetermined algorithm, determined on the fly by network monitoring components, or the like.

When applying the functionality of relevance classifier device 240 in this exemplary scenario, a single weighted intent may be assigned for each of the available queues. In another example, a series of weighted intents may be assigned to each of the available queues, based on the selections made by the end user or any additional data collected on dialog 205(a), as additional context or purpose may be gleaned with the availability of a series of intents. Optimally, a series of weighted intents would take into consideration all available information and all options for tasks which result from end user's 201 available options.

As noted above, as part of relevance classifier device 240 creating the relevance discovery report 240(a), additional information is collected on the interaction, in one example, metadata associated with the interaction, including but not limited to phone number dialed, type of device upon which the dialog was initiated (mobile, desktop, softphone, etc.), caller ID of the end user device, “customer” information associated with the end user maintained by the business entity, queue connected to, any associated ticket number(s) associated with the customer information, time stamp, and the like. This additional information may further inform the weighted intent assignments, as described in reference herein.

Other systems 204 can be any system or device within a business entity that may provide data and information to presence availability discovery device 210, including but not limited to, network monitoring and metadata collection tools, other data mining tools, contact lists, customer relationship management (CRM) systems, and the like.

In this exemplary environment, end user 201 is human and calls the technical support phone number to discuss a technical issue with the second service and the call connects. End user 201 is offered a series of options to choose from through the integrated IVR technology. In this exemplary embodiment, as illustrated in FIG. 2, end user 201 is offered two options, support for a first service 205(b) or support for a second service 205(c). Upon selecting a service (which for ease of illustration in FIG. 2, end user 201 has selected service for the second service 205(c), end user is offered two additional options, to either create a new ticket 205(d) or to update/add to an existing ticket 205(e). In this limited example, the identification assigned to this dialog is voice call/human and the context assigned is to receive technical support. Based on the option end user 201 selects, either create a new ticket 205(d) or update/add to an existing ticket 205(e), additional information will be requested, for example, the technical issue end user 201 is experiencing, etc. to populate the new or existing ticket.

In this example, where update/add to an existing ticket 205(e) is selected, end user 201 may be prompted, in one non-limiting example, to enter an account number or an existing ticket number, if available. With any additional information collected as metadata or from other systems 204, the weighted intent, and in additional embodiments, an at least one weighted intent or a one or more weighted intents, assigned to this identification and this context within relevance discovery report 240(a) may be a value created based on a business rule of the business entity which allocates a certain priority to the creation of a new ticket for as compared to a different weighted intent based on a business rule of the business entity which allocates a different priority to updating an existing ticket. In an exemplary embodiment where a series of weighted intents are assigned, certain weighted intents may be assigned based on the vocabulary used with the ticket content, if this is a status/add to of an existing ticket 205(e), the time period between the previous request and the current request, and the like.

Note the decision tree and corresponding logic are illustrated in FIG. 2 with the not selected pathways either in greyscale or not marked. In exemplary embodiments where different options are selected by end user 201, similar logic and methodology would apply, however the decision tree and corresponding logic would denote a different pathway for dialog 205(a). If the end user is an AI, for example, similar logic and methodology may apply but be modified for the responsive form of communication the AI device may interpret and receive as responsive.

Once relevance discovery report 240(a) is created by relevance classifier device 240, connected worker identifier device 250 is activated to parse relevance discovery report 240(a) to create a list of the connected workers, and in additional embodiments, an at least one connected workers or a one or more connected workers, most responsive to dialog 205(a) and end user 201, through correlation of the weighted intents against a list of the connected workers. In this exemplary embodiment, the list of the connected workers further comprises each of the connected workers listed having (1) an associated identifier, (2) an at least one availability marker, (3) an at least one skill, and (4) an at least one skill ranking and this list is prioritized by (1) the at least one availability marker, (2) the at least one skill, and (3) the at least one skill ranking when compared to relevance discovery report 240(a).

For ease of illustration, the business entity has connected workers for each service, which for ease of illustration in FIG. 2, are depicted in technical support environment 206 as Product 1 Team 207 and Product 2 Team 208, with Product 2 Team 208 members listed as their associated identifier. FIG. 2A illustrates a matrix of each connected worker identified by their associated identifier, and showing each connected worker has five skills and a skill ranking of one through five for each skill, one being the highest ranking and five being the lowest ranking. Also, for ease of illustration, the business entity has a preset number of four availability markers for its connected workers. As denoted in FIG. 2A, in this scenario, each connected worker, at any time can have the following availability markers: (A) not available for call but available for email, (B) available for call and not available for email, (C) available for call and available for email, and (D) not available for call and not available for email.

As illustrated in FIG. 2, as supplemented by FIG. 2A, where update an existing ticket 205(e) was selected and end user 201 provided further content which referenced Issue 2 and the list of connected workers is prioritized for the dialog and end user based on (1) the availability marker, (2) skills, and (3) the skill ranking when compared to the relevance discovery report, the connected workers may, in one non-limiting example, be prioritized as 45678, 23456, 12345, 34567, and 56789. Additional exemplary embodiments are contemplated where various of the columns listed in FIG. 2A may have different weights, which may skew the prioritization, for example, updating an existing ticket has a heavier weighted value than Issue 2, the prioritization may occur as follows: 23456, 45678, 34567, 56789, and 12345.

Note the decision tree and corresponding logic are illustrated in FIG. 2 with the not selected pathways either in greyscale or not marked, for example Product 1 Team 207 is denoted in greyscale and not further designated by associated identifiers. In exemplary embodiments where different options are selected by end user 201, similar logic and methodology would apply, however the decision tree and corresponding logic would denote a different pathway for dialog 205(a). If the end user is an AI, for example, similar logic and methodology may apply but be modified for the responsive form of communication the AI device may interpret and receive as responsive.

Generally, presence management in communications and computing is generally the ability to know when each connected worker is (1) available for communication and (2) for what kind of communication. Most commonly, the designation would be with a singular modality, available—phone call; not available—email, etc. Availability, in contrast, generally means the ability of an end user to access resources in a specified location and in the correct format. As a novel aspect of the present invention, availability is extended with the presence availability discovery device able to determine “correct format” actively or passively by the connected worker and/or the connected worker's surroundings and available modalities.

Oftentimes, and as is contemplated herein in reference to FIG. 2 (and the following exemplary illustrations), availability is a feature as determined by actions of a connected worker. In traditional modal channels, such as chat, SMS, video, etc., a connected worker would log into some sort of system or software, and upon login, would be automatically designated as “available” unless a system monitor determines the connected worker is actively engaging in an interaction using any one or all of the available modality channels for communication. In its most traditional sense, presence availability discovery device 210, does collect availability data for connected workers based on these modal channels, as business entities still continue to maintain communication products and services which have this type of functionality and features. Once presence availability discovery device 210 is configured to integrate with these traditional communication channels, the collected availability information is used to inform connected worker identifier device 150.

However, the terms “locations,” “presence,” and “available” further comprise anything on which a position of a user may be expressed, e.g., the physical, virtual and ordinal location of the user. The physical location may be determined in many ways, including, but not limited to, manual input from a user, Global Positioning System (GPS) information, Assisted GPS and wireless signal triangulation. The virtual location may be expressed including, but not limited to, the current page(s) being browsed and positions within multi-dimensional virtual environments or interactive multimedia presentations. Also, the ordinal location may be expressed as the location within including, but not limited to, user interface displays, and positions within streamed and/or broadcast content, such as song on a radio station or television show on a video channel. An essential feature of a traditional presence system is to communicate the state of a person in an abstract form to others that may be interested in and allowed to access this information. When looking into physical environments, it becomes apparent, that presence functionality can be extended to objects and environments. A generic presence system can essentially be seen as a system to share context information.

Further embodiments are contemplated where sensors analyze audio from the built-in microphone of a laptop computer to detect speech. Speech has been shown to be a very good indicator that a connected worker is busy and should probably not be interrupted. Additional embodiments are contemplated to use speech detection, location information, computer activity, and calendar information to model a connected worker's availability, where these sensors are relational to availability because they can reasonably be considered for large-scale deployment. Additional embodiments are contemplated where priorities system examine incoming messages and, if a connected worker is not present, forwards urgent messages to another computing device or mobile device. Further additional embodiments are contemplated, such as a coordinate system, which uses calendar information and previous computer activity to model the likelihood of a connected worker being available on a particular computing device, such as a desktop computer or a PDA, but not available on other devices, such as a mobile client or softphone device. Yet further embodiments are contemplated to sense, monitor, and trend temporal patterns in a connected worker's presence to estimate when that connected worker might be likely to return. In one non-limiting example, a connected worker who is usually present at a given time of day might be available at that time even if the connected worker's computer has been inactive for several minutes, as in the case where the connected worker is reading near the computer. Additional embodiments are contemplated to monitor and sense the inverse, situations where a connected worker might be present but not available.

In extending the exemplary embodiment illustrated in FIG. 2, if the business entity has more communications channels to its technical support environment 206 than just a phone number and an email address, for example, chat, SMS/MMS, and video conference/messaging, the availability markers would increase substantially, the availability markers would number twenty five, with a different designation given for availability in each of the modalities.

Thereafter, as further illustrated in FIG. 2, with the prioritized list of connected workers available, connected worker router 260, interprets the list of the at least one, or one or more connected workers most responsive to dialog 205(a) and connected worker router 260 directs dialog 205(a) to the one or more connected workers in a prioritized order. For ease of illustration here in FIG. 2, dialog 205(a) is directed and delivered to connected worker 34567. Direction of the dialog to the connected workers in a prioritized order will be discussed in more detail in reference to FIG. 3, below.

Also, presence availability discovery device 210 further comprises memory 270, controller 280, and network connector 298, which for ease of description offer the same coupling, direction, and control to presence availability discovery device 210 as described previously with reference to the corresponding elements in FIG. 1. Network connector 298 functions as illustrated in FIG. 2, to connect presence availability connection device 210 to network 290.

Network 290, each cloud as illustrated individually and collectively referenced as a network (i.e., “network 290”) as used herein generally include any kind of computer-enabled, IP-enabled, or other digital network or networks for transporting data or traffic associated with communication sessions, and generally include a network in a system of interconnected computing devices, servers, nodes, or endpoints, by no way in limitation but for example, each element as illustrated in FIG. 2: initiating party 202, support email queue 202, support call queue 203, other systems 204, presence availability discovery device 210, and technical support environment 206. As illustrated, network 290, each represents a connected yet different network in a series. In one example, a network includes the Internet that is a global system of interconnected computers that use the standard IP suite to serve end users worldwide with an extensive range of information resources and services. It should also be understood that the term “Internet” as used herein and generally, in reality, is a network of networks consisting of millions of private, public, academic, business, and government networks, of local to global scope, that is linked by a broad array of electronic, wireless and optical technologies.

Usually, such networks are offered as commoditized services by third-party Internet service providers (ISPs) and include a plurality of one or more third-party sub-networks that are usually owned by third party network providers or third-party carriers. Such sub-networks can be hard-wired or wireless, including, but not limited to, cellular, optical fiber, Wi-Fi, WiMax®, proprietary networks, and the like, as should occur to one skilled in the art. It should also be understood by one skilled in the art that network 290 can further include PSTN nodes such as IP-PSTN gateways (not shown) at the boundary of IP networks, which can function as a conversion between PSTN traffic and IP traffic.

FIG. 3, illustrates a second exemplary embodiment which extends the first exemplary embodiment by adding an additional, and in further embodiments, an at least one, or a one or more, channel of communication to the communication flow, creating by default, multiple, multidirectional communication flows across multiple channels within a business entity. For this exemplary embodiment, a technical support department 306, which has its customer-facing channels (from the previous exemplary embodiment, the support phone number and the support email) as discussed above, which here will be defined as “public facing,” “external,” and “general” channels, will also include a channel to another department within the business entity, the DevOps department 309, which here will be defined as an “internal” and “private” channel. This channel with DevOps department 309 occurs simultaneously and in real time with the public facing channels, subject to the same application of presence availability discovery device 310 in a slightly different, more complex manner.

DevOps is generally a set of practices that combine software development functions and information technology (IT) functions, with the aim to shorten the development lifecycle and provide continuity in delivery of software products and services, by providing a department which has both development knowledge and capabilities along with escalated technical support and troubleshooting knowledge and capabilities. In this exemplary embodiment, technical support department 306 relies on DevOps department 309 for escalation of non-standard technical support requests, additional troubleshooting, and also to track and maintain trending information for the types of issues and concerns raised by incoming requests to the technical support department.

Where a business entity has presence availability discovery device 310 configured for multiple multidirectional communication flows between departments, such as this exemplary embodiment, additional complexity in the business rules are contemplated surrounding the population of the lists contained in context database 374 accessible to content identifier device 330, relevance database 376 accessible to relevance classifier device 340, and connected worker database 178 accessible to connected worker identifier device 250, where they are respectively correlated identifiers for communications in the internal, private channel. One aspect of this additional complexity surrounds the permissions limiting sharing and viewing of available channels. For ease of illustration of this exemplary embodiment, the communication channel modality between technical support department 306 and DevOps department 309 is limited to chat only. Therefore, the identification assigned by dialog identifier device 320 in this instance would be human/chat.

The first list of contexts and second list of contexts indexed in context database 374 accessible to context identifier device 230, however, where the private, internal channel is in use, may include additional context types relating to what connected workers with what permissions are listed in the list of connected workers for DevOps department 309. Additional contexts may also relate to the content of any chat communications drafted, by way of example and not in limitation, certain key words, like “escalation,” “rush,” “priority,” and the like may inform the assignment of a context when used in conjunction with other key words, in one non-limiting set of examples, “outage,” “downtime,” and the like. In this way, as an aspect of this exemplary embodiment, it is contemplated that these lists of contexts be monitored and updated in a more dynamic, on the fly manner so as to account for varying availability of connected workers at a given time. Also of note, in this exemplary embodiment, it is further contemplated that an at least one or a one or more context is assigned to dialog 308(a) and to the end user, which in this limited embodiment, is connected worker 34567. In this manner, the evaluation by relevance classifier device 240 would include parsing an at least one or a one or more matrices of contexts associated with dialog 308(a) and the connected worker 34567.

In the same manner as described above, in reference to FIGS. 1 and 2, additional information may also be collected on the interaction, in one example, metadata associated with the chat dialog initiated by the connected worker 34567, by way of example, geolocation data, time stamp, IP address or other device identification, and the like. It is further contemplated that as the metadata collected initially in the general, public channel associated with dialog 305(a) is also included, to fully inform relevance classifier device 340 in creating relevance discovery report 340(a).

Other systems 302 can be any system or device within a business entity that may provide data and information to presence availability discovery device 310, including but not limited to, network monitoring and metadata collection tools, other data mining tools, contact lists, customer relationship management (CRM) systems, and the like.

Likewise, relevance classifier device 340, may access a list of all supported contexts which have additional supported context aspects due to which connected workers with what permissions are listed in the list of connected workers for DevOps department 309. In creating relevance discovery report 340(a), it is contemplated that relevance classifier device 340 parse an at least one or a one or more matrices of contexts and additional collected information associated with dialog 308(a) and connected worker 34567.

The list of connected workers indexed in connected worker database 378 accessible to connected worker identifier device 350 can optionally include further complexity in the listing of an at least one or a one or more skill and/or an at least one or one or more skill ranking. This additional complexity may further inform connected worker identifier device 350 for controlling the sharing of information.

For ease of illustration, in this exemplary embodiment as illustrated in FIG. 3, connected worker 308(a) is reaching out to DevOps department 309 with an escalation related to Issue 2 (as described with reference to FIGS. 2 and 2A). Issue 2, however, has confidential information concerns as it relates to a form of personally identifiable information or PII, and requires only a connected worker in DevOps department 309 who has an admin permission to review and troubleshoot. Further, as illustrated in FIG. 3A, each connected worker listed in the list of connected workers (which, for ease of illustration in this example, are all of those connected workers on DevOps Team 307) in this exemplary embodiment has one of two availability markers: (A) available or (B) not available. Also, each connected worker has two types of skills. One type relates to DevOps functionality and has associated skill rankings of one to five, with one being the highest ranking. The second type relates to permissions and has associated skill rankings of one to two, with one being permission allowed and two being no permission allowed.

As illustrated in FIG. 3, and supplemented by FIG. 3A, where update an existing ticket was requested in the external channel, further content was provided which referenced Issue 2, which was then escalated in dialog 308(a) by connected worker 34567, list of connected workers for DevOps Team 307 is prioritized for dialog 308(a) and connected worker 34567 based on (1) the availability marker, (2) skills, and (3) the skill ranking when compared to relevance discovery report 340(a), the connected workers would be prioritized as 67890, 89012, 01234, 78901, and 90123.

In extending this exemplary embodiment, if the business entity has more communications channels between technical support department 306 and DevOps department 309 than just chat, for example, SMS/MMS, video conference/messaging, and document exchange, the availability markers would increase substantially, and the availability markers would number twenty five, with a different designation given for availability in each of the modalities.

Thereafter, with the prioritized list of connected workers available, connected worker router 360, interprets the list of the at least one, or one or more connected workers most responsive to dialog 308(a) and connected worker router 360 directs dialog 308(a) to the one or more connected workers on DevOps Team 307, in a prioritized order. Direction of dialog 308(a) to the connected workers in a prioritized order may optionally occur in many different configured manners. In a singular limited example as it relates to this exemplary embodiment illustrated in FIG. 3, since the modality of communication between technical support department 306 and DevOps department 309 is chat, “prioritized” delivery here would be the chat message content would be delivered simultaneously to the two connected workers that have the admin permission, connected worker 67890 and connected worker 89012. Prioritized routing of communications calls, messages, data, and other signals, however, may optimally occur through any one or more of the following know traffic routing principles, including but not limited to, priority routing, weighted routing, performance routing, geographic routing, multivalue routing, subnet routing, and the like.

Particularly in a chat modality environment, as contemplated in this exemplary embodiment, chat streams or channels can occur as “conversation threads” or “threads.” Conversation threading is generally a feature used by in chat modalities, email clients, bulletin boards, newsgroups, online forums, and the like, in which the “conversations” are visually grouped messages, with their replies and responses. Threads can be displayed in a variety of ways. Generally, threaded systems will automatically include original message text in a reply, making each individual content element into its own copy of the entire thread. Threads may also be arranged as lists, but can also be hierarchical or nested, arranging messages close to their replies in a tree, or they can be linear or flat, displaying all messages in chronological order regardless of reply relationships.

In the context of the present exemplary embodiment, the chat “communication channel” between technical support department 306 and DevOps department 309 can be viewed as threads which can have cross or “shared” conversation threading capabilities. For example, when connected worker 34567 reaches out to DevOps department 309 with an escalation related to Issue 2, the connected worker 34567 will initiate a chat or thread to DevOps Team 307, without knowing particularly which connected worker in DevOps Team 307 should or is able to respond to the chat (which for ease of illustration, comprises only the connected workers associated with the connected worker IDs listed in the table illustrated in FIG. 3A). However, with the application of relevance discovery report 340(a), the thread will be only viewable by the connected workers 67890 and connected worker 89012, as dialog 308(a) contains confidential information concerns as it relates to a form of personally identifiable information or PII, and requires only a connected worker in DevOps Team 307 who has an admin permission to review and troubleshoot. Further complexity in prioritized delivery in this exemplary embodiment, since connected worker 67890 has the availability marker A, dialog 308(a) will be delivered to this connected worker 67890 first (even though it will also be delivered to connected worker 89012 simultaneously, but will remain unread until such time that connected worker 89012 is available), who will likely respond. In the event connected worker 67890 does not respond, the thread will remain open to connected worker 89012. Additional embodiments further contemplate that in the event that neither connected worker 67890 nor connected worker 89012 respond to dialog 308(a) within a certain period of time that notification will be directed to DevOps Team 307 about further prioritization and delivery of dialog 308(a).

Additional embodiments contemplate where connected workers, in this context, will be able to mark individual threads as “private” or “offline” or responded to out of order. With conversational threading, it is much easier to reply to individual messages that are not the most recent message in the thread. As a result, multiple threads of discussions often occur in parallel.

Certain business entities will not require as specific of an application configuration of the presence availability discovery device, i.e., certain business entities may consider all of its employees resources to extent that all employees would be considered connected workers in the context of the inventive concept presented in this specification and its complementary claims. Therefore, there are configurations of the present invention contemplated where call queues and other queues are not in use, where all employees within a business entity are connected workers listed in the list of connected workers stored in the connected worker database that the connected worker identifier device has access to via a network, for either and both initiating and receiving dialogs with various modalities. The complexity in this model occurs with multiple multidirectional communication streams across multiple modalities with any number of public, general facing channels and internal, private channels.

Also, presence availability discovery device 310 further comprises memory 370, controller 380, and network connector 398, which for ease of description offer the same coupling, direction, and control to presence availability discovery device 310 as described previously with reference to the corresponding elements in FIG. 1. Network connector 398 functions as illustrated in FIG. 3, to connect presence availability connection device 310 to network 390 (which has the same or similar functionality to network 290, described in reference to FIG. 2). Network 390 generally includes a system of interconnected computing devices, servers, nodes, or endpoints, by no way in limitation but for example, each element as illustrated in FIG. 3: other systems 302, presence availability discovery device 310, technical support department 306, and DevOps department 309.

As illustrated in FIG. 4, dialog identifier device 420, in assigning an identification by correlating both an initiated dialog 411(a), 412(a) and connected worker 1 411 each against a list of acceptable modality types and a list of all end user types may assign at least one or one or more identifications, as follows: human/voice call, human/chat, human/SMS/MMS, human/video, human/document sharing, human/form submission, human/review form, AI/voice call, AI/chat, AI/SMS/MMS, AI/video, AI/document sharing, AI/form submission, or AI/review form. Further embodiments are contemplated where multiple modalities may be used simultaneously, for example, SMS/MMS and document sharing or video and chat (which for exemplary illustration, dialog 412(a) has multiple modalities). In these exemplary embodiments, the list of modality types may be a matrix with various priority algorithms applied to determine which is the primary, secondary, tertiary, etc. modality in use in the initiated multimodal dialog.

Presence availability discovery device 410, at dialog identifier device 420, can in exemplary embodiments, be configured to be limited to predetermined sets of modality and end user types contained in the identification database, or in additional exemplary embodiments the types may be dynamically set by a system administrator, determined on the fly by network monitoring components, or the like. In this particular exemplary embodiment, with the addition of possible multiple modalities, it is further contemplated that identification database 472 may be monitored by an AI implementation and updated based on configurable communication patterns.

Further embodiments are contemplated where end user types may have at least one or one or more aspects listed for end user type besides human or AI, by way of non-limiting example, any of a variety of device user types that a business entity may wish to assign, any of a variety of department or employee title types that a business entity may wish to assign, and the like. In these exemplary embodiments, the list of end user types may be a matrix with various priority algorithms applied to determine which is the primary, secondary, tertiary, etc. end user type for who initiated the dialog. In this particular exemplary embodiment illustrated in FIG. 4, with the addition of possible multiple end user types, it is further contemplated that identification database 472 may be monitored by an AI implementation and updated based on configurable communication patterns.

As described above, this particular exemplary embodiment illustrated in FIG. 4 contemplates the business entity having presence availability discovery device 410 configured for multiple multidirectional communication flows between internal and external facing channels and between internal facing channels, which further contemplates additional complexity in the business rules applied to populating the lists contained in context database 474 accessible to context identifier device 430, relevance database 476 accessible to relevance classifier device 440, and connected worker database 478 accessible to connected worker identifier device 450, where they are respectively correlated identifiers for communications in public channels, internal channels, and cross-communications between either or both the external and internal channels. One aspect of this additional complexity surrounds the permissions limiting sharing and viewing of available channels. Expanding on the prior exemplary embodiment, the communication channel modality between the external channels and the internal channels may be all available modalities.

The first list of contexts and second list of contexts indexed in context database 474 accessible to context identifier device 430, however, where both an external and internal channel are in use, may include additional context types relating to what connected workers with what permissions are listed in the list of connected workers stored in connected worker database 478. Additional contexts may also relate to the content of any dialog, by way of example and not in limitation, certain key words, like “escalation,” “rush,” “priority,” and the like may inform the assignment of a context when used in conjunction with other key words, in one non-limiting set of examples, “outage,” “downtime,” and the like. In this way, as an aspect of this exemplary embodiment, it is contemplated that these lists of contexts be monitored and updated in a more dynamic, on the fly manner so as to account for varying availability of connected workers at a given time. Also of note, in this exemplary embodiment, it is further contemplated that an at least one or a one or more context is assigned to dialog 411(a), 412(a) and to connected worker 1 411 and connected worker 2 412. In this manner, the evaluation by relevance classifier device 440 would include parsing an at least one or a one or more matrices of contexts associated with dialog 411(a), 412(a), connected worker 1 411, and connected worker 2 412. In this particular exemplary embodiment, with the addition of parsing of multiple matrices of contexts, it is further contemplated that context database 474 may be monitored by an AI implementation and updated based on configurable communication patterns.

In the same manner as described above, additional information may also be collected on the interaction, in one example, metadata associated with the dialog initiated by an end user, whether or not the end user is initiating the dialog from an external or internal communication channel, geolocation data, time stamp, IP address or other device identification, and the like, collected, for example, via other systems 402 coupled to presence availability discovery device 410. Likewise, relevance classifier device 440, may access a list of all supported contexts which have additional supported context aspects due to what connected workers with what permissions are listed in the list of connected workers. In creating relevance discovery report 440(a), it is contemplated that relevance classifier device 440 parse an at least one or a one or more matrices of contexts and additional collected information associated with dialog 411(a), 412(a), connected worker 1 411, and connected worker 2 412. As illustrated here in FIG. 4, in this particular exemplary embodiment, with the addition of parsing of multiple matrices of contexts, it is further contemplated that the context database may be monitored by an AI implementation and updated based on configurable communication patterns.

Other systems 402 can be any system or device within a business entity that may provide data and information to presence availability discovery device 410, including but not limited to, network monitoring and metadata collection tools, other data mining tools, contact lists, customer relationship management (CRM) systems, and the like.

The list of connected workers indexed in connected worker database 478 accessible to connected worker identifier device 450 can optionally include further complexity in the types associated with each of the connected workers. Where dialog 411(a), 412(a) may be initiated either or both externally and internally, the designation of a connected worker may have multiple elements, depending on an end user initiating a particular dialog, by way of non-limiting example, if only internal parties are part of a dialog, additional elements related to “internal only” availability may be listed. Additionally, in the listing of an at least one or a one or more skill and/or an at least one or one or more skill ranking, skills and skill rankings may have multiple elements to address various job duties, external and internal contacts, and the like. This additional complexity may further inform connected worker identifier device 450 for controlling the sharing of information. In these exemplary embodiments, the list of connected workers may be a matrix, in additional embodiments, a series of matrices, with various priority algorithms applied to determine which is the primary, secondary, tertiary, etc. of each of the connected worker attributes to be the most responsive to the initiated multimodal dialog. In this particular exemplary embodiment, with the addition of parsing of multiple matrices of connected workers attributes, it is further contemplated that connected worker database 478 may be monitored by an AI implementation and updated based on configurable communication patterns.

Skill-based routing (or skill-based distribution) has historically been a concept applicable to call routing within a call center, where callers are assigned to agents with the “most relevant” skills for handling their concerns. While simple automatic call distributor (ACD) systems were designed to route calls to the next available agent irrespective of that agent's expertise, skills-based routing allows call centers and contact centers to designate agents as specialists in certain products or issues. Limitations exist, however, with traditional skills-based routing protocols, for example, it has generally been limited to call centers and voice calls only, with the further limitation that agents answering calls were generally able to be assigned to only one call queue taking one type of call. This meant that agents who could deal with a range of call types had to be manually reassigned to different call queues at different times of the day to make the best use of their skills, or face being exposed to a wide variety of calls for which they were not trained. Another limitation in traditional skills based routing systems is that the skills needed for a particular call are often assessed by the dialed telephone number and the calling number or caller's identity, as well as choices made in any associated IVR system. Given this assessment, a skills-based routing system then attempts to match the call to a suitably trained agent—the thinking being that an agent with matching skills will be able to provide a better service than one who does not.

Presence management, as described previously, in communications and computing is generally the ability to know when each connected worker is (1) available for communication and (2) for what kind of communication. Most commonly, the designation would be with a singular modality, available—phone call; not available—email, etc. Availability, in contrast, generally means the ability of an end user to access resources in a specified location and in the correct format. As a novel aspect of the present invention, availability is extended with the presence availability discovery device able to determine “correct format” actively or passively by the connected worker and/or the connected worker's surroundings and available modalities.

In the exemplary embodiment illustrated in FIG. 4, for simplification of illustration, three connected workers 411, 412, 413, internal-only to a business entity (only for purposes of this illustration, in a real world scenario, connected workers 411, 412, 413 would have both multiple multidirectional communication flows available to them with both internal facing and external facing capabilities). Connected worker 1 411 attempts to initiate dialog 411(a) to connected worker 3 413, however this dialog is unable to connect as described below. Connected worker 2 412 initiates dialog 412(a), which can be delivered to connected worker 3 413. Each of the connected workers 411, 412, 413 have a “quiet room” functionality configured as part of the implementation of presence availability discovery device 410, in this exemplary embodiment. As part of this configuration, each of connected workers 411, 412, and 413 each have a black list, white list, and GPS enabled, but for ease of illustration, as dialogs 411(a) and 412(a) are flowing only to connected worker 3 413, only connected worker 3 413 is illustrated as having a coupled blacklist 415, whitelist 416 and GPS 417.

As discussed previously with reference to FIG. 2, oftentimes, availability is a feature as determined by actions of a connected worker. In traditional modal channels, such as chat, SMS, video, etc., a connected worker would log into some sort of system or software, and upon login, would be automatically designated as “available” unless a system monitor determines the connected worker is actively engaging in an interaction using any one or all of the available modality channels for communication. In its most traditional sense, presence availability discovery device 410, does collect availability data for connected workers based on these modal channels, as business entities still continue to maintain communication products and services which have this type of functionality and features. Once presence availability discovery device 410 is configured to integrate with these traditional communication channels, the collected availability information is used to inform connected worker identifier device 150.

Along this vein, blacklist 415 and whitelist 416 are functionally manually created and activated by connected worker 3 413. In computing and communications services, a blacklist, such as, for example, blacklist 415 is a basic access control mechanism that allows through all elements (email addresses, users, passwords, URLs, IP addresses, domain names, file hashes, and the like), except those explicitly mentioned. Those items on the list are denied access. As contemplated herein, blacklist 415 would contain a list of end users, other connected workers, modality types, dialog types, and the like, that when this functionality is activated, connected worker 3 413 would not receive communications or dialogs associated with such. The opposite is a whitelist, such as, for example, whitelist 416, in which only items on the list are let through whatever gate is being used. Additional embodiments are contemplated where a greylist may be implemented, where a greylist contains items that are temporarily blocked (or temporarily allowed) until an additional step is performed.

Example uses of a blacklist may include a company that might prevent a list of software from running on its network, a school that might prevent access to a list of websites from its computers, or a business that wants to ensure their computer users are not choosing easily guessed, poor passwords.

Whitelisting, on the other hand, is the practice of explicitly allowing some identified entities access to a particular privilege, service, mobility, access or recognition. It is the opposite of blacklisting. As contemplated herein, whitelist 416 would contain a list of end users, other connected workers, modality types, dialog types, and the like, that when this functionality is activated, connected worker 3 413 would receive communications or dialogs associated with such, even if other do not disturb or other blacklist features are activated.

As illustrated in FIG. 4, connected worker 3 413 has activated blacklist 415 and white list 416. As such, dialog 411(a) was rejected, as noted by the terminator, meaning that connected worker 1 411 or dialog 411(a), in some fashion, must be listed on blacklist 415, while dialog 412(a) was accepted, as noted by the connection to connected worker 3 413, meaning that connected worker 2 412 or dialog 412(a), in some fashion, must be listed on whitelist 416.

Also as noted above with reference to FIG. 2, “location” and “available” further comprise anything on which a position of a connected worker may be expressed, e.g., the connected worker's physical, virtual and ordinal location of the user. The physical location may be determined in many ways, including, but not limited to, manual input from a user, Global Positioning System (GPS) information, Assisted GPS and wireless signal triangulation, for example GPS 417. The virtual location may be expressed including, but not limited to, the current page(s) being browsed and positions within multi-dimensional virtual environments or interactive multimedia presentations. Also, the ordinal location may be expressed as the location within including, but not limited to, user interface displays, and positions within streamed and/or broadcast content, such as song on a radio station or television show on a video channel. An essential feature of a traditional presence system is to communicate the state of a person in an abstract form to others that may be interested in and allowed to access this information. When looking into physical environments, it becomes apparent, that presence functionality can be extended to objects and environments. A generic presence system can essentially be seen as a system to share context information. Additional embodiments are contemplated where if connected worker 3 413 were, for example, driving GPS 417 would inform presence availability discovery device 410 that connected worker 3 413 would be available for only a limited subset of modalities, for example, phone calls, as all others would be difficult to participate in while driving.

Thereafter, with the prioritized list of connected workers available, connected worker router 460, interprets the list of the at least one, or one or more connected workers most responsive to the dialog and connected worker router 460 directs dialog 412(a) to connected worker 3 413, in a prioritized order. Direction of the dialog to the connected workers in a prioritized order may optionally occur in many different configured manners. Prioritized routing of communications calls, messages, data, and other signals, however, may optimally occur through any one or more of the following know traffic routing principles, including but not limited to, priority routing, weighted routing, performance routing, geographic routing, multivalue routing, subnet routing, and the like.

Additional methods, aspects, and elements of the present inventive concept are contemplated to be used in conjunction with, individually or in any combination thereof, which will create a reasonably functional presence availability discovery device, system, and any applicable complementary methods for discovery of availability corresponding to interactions of one or more end user. It will be apparent to one of ordinary skill in the art that the manner of making and using the claimed invention has been adequately disclosed in the above-written description of the exemplary embodiments and aspects. It should be understood, however, that the invention is not necessarily limited to the specific embodiments, aspects, arrangement, and components shown and described above, but may be susceptible to numerous variations within the scope of the invention.

Moreover, particular exemplary features described herein in conjunction with specific embodiments or aspects of the present invention are to be construed as applicable to any embodiment described within, enabled through this written specification and claims, or apparent based on this written specification and claims. Thus, the specification and drawings are to be regarded in a broad, illustrative, and enabling sense rather than a restrictive one. It should be understood that the above description of the embodiments of the present invention is susceptible to various modifications, changes, and adaptations, and the same are intended to be comprehended within the meaning and range of equivalents of the appended claims.

1. A presence availability discovery device, comprising a series of computing devices coupled via a network connector to match a one or more connected workers to a multimodal dialog initiated by an end user, comprising:
a dialog identifier device, wherein the dialog identifier device identifies and assigns an at least one identification to (1) the multimodal dialog and to (2) the end user by correlating the multimodal dialog among a list of modality types and correlating the end user among a list of end user types, wherein the list of modality types and the list of end user types are indexed in an identification database accessible to the dialog identifier device via the network connector;
a context identifier device, wherein the context identifier device assigns an at least one context to (1) the multimodal dialog and to (2) the end user by correlating the multimodal dialog among a first list of contexts and correlating the end user among a second list of contexts, wherein the first list of contexts and the second list of contexts are indexed in a context database accessible to the context identifier device via the network connector;
a relevance classifier device, wherein the relevance classifier device creates a relevance discovery report based on the at least one identification and the at least one context by assigning a one or more weighted intents to (1) the at least one identification and to (2) the at least context based on correlating the at least one identification against a list of all supported identifications and correlating the at least one context against a list of all supported contexts, wherein the list of all supported identifications and the list of all supported contexts are indexed in a relevance database accessible to the relevance classifier device via the network connector;
a connected worker identifier device, wherein the connected worker identifier device parses the relevance discovery report to create a list of the one or more connected workers most responsive to (1) the multimodal dialog and to (2) the end user by correlating the one or more weighted intents against a list of the one or more connected workers indexed in a connected worker database accessible to the connected worker identifier device via the network connector, whereby the list of the one or more connected workers further comprises each of the one or more connected workers listed having (1) an associated identifier, (2) an at least one availability marker, (3) an at least one skill, and (4) an at least one skill ranking;
whereby the list of the one or more connected workers most responsive to the multimodal dialog is prioritized by (1) the at least one availability marker, (2) the at least one skill, and (3) the at least one skill ranking;
a connected worker router, wherein the connected worker router interprets the list of the one or more connected workers most responsive to the multimodal dialog and the connected worker router directs the at least one multimodal dialog to the one or more connected workers in a prioritized order;
a memory, wherein the memory is coupled to the dialog identifier device, the context identifier device, the relevance classifier device, the connected worker identifier device, and the connected worker router device via the network connector, wherein the memory stores and couples the identification database, the context database, the relevance database, and the connected worker database; and
a controller, further comprising:
an operating system, wherein the operating system directs and controls the operation and function of the dialog identifier device, the context identifier device, the relevance classifier device, the connected worker identifier device, the connected worker router device, and
an input/output module, wherein the input/output module provides basic control and input/output operations to the presence availability discovery device via the network connector.

2. The presence availability device of claim 1, wherein the list of modality types further comprises voice, chat, short messaging, multimedia messaging, video, document sharing, form submissions, and review form.

3. The presence availability device of claim 1, wherein the list of end user types further comprises human and artificial intelligence, as end user types.

4. The presence availability device of claim 1, wherein the list of end user types further comprises human, artificial intelligence, a job title, and an at least one skill, as end user types.

5. The presence availability of claim 1, wherein the list of content types of multimodal dialogs further comprises an at least one metadata associated with the content types of multimodal dialogs.

6. The presence availability device of claim 1, wherein the one or more weighted intents further comprises at least one matrix of intents weighted based on use of at least one keyword within a content of the at least one multimodal dialog.

7. The presence availability device of claim 1, wherein the at least one availability marker is manually activated by the one or more connected worker, further comprising: available, not available, and do not disturb except for whitelist.

8. The presence availability device of claim 1, further comprising an availability channel monitor which monitors the one or more connected workers presence within a set of communication channels and selects the at least one availability marker listed in the list of the one or more connected workers based on the one or more connected workers presence within the set of communication channels.

9. The presence availability device of claim 1, wherein the at least one availability marker is determined based on an activation of a sensor within an object associated with the one or more connected workers.

10. The presence availability device of claim 1, wherein the at least one availability marker is determined based on a geolocation activation within a satellite-based radio navigation system.

11. The presence availability device of claim 1, wherein the at least one skill is determined dynamically based on an artificial intelligence system monitoring the at least one dialog and parsing its content and assigning the at least one skill to the at least one connected workers based on the parsing.

12. The presence availability device of claim 1, wherein the at least one skill ranking is determined dynamically based on an artificial intelligence system monitoring the at least one dialog and parsing its content and assigning the at least one skill ranking to the at least one connected workers based on the parsing.

13. The presence availability device of claim 1, wherein the list of the one or more connected workers most responsive to the multimodal dialog is prioritized with the highest priority weight given to the at least one availability marker. The presence availability device of claim 1, wherein the connected worker router directs the at least one multimodal dialog to the one or more connected workers with the highest priority weight given to the at least one availability marker.

15. A system, comprising:
an at least one end user;
an at least one connected worker;
an at least one network; and
a presence availability discovery device, comprising a series of computing devices coupled via a network connector to the network to match the at least one connected worker to an at least one multimodal dialog initiated by the at least one end user, comprising:
a dialog identifier device, wherein the dialog identifier device identifies and assigns an at least one identification to (1) the at least one multimodal dialog and to (2) the at least one end user by correlating the multimodal dialog among a list of modality types and correlating the at least one end user among a list of end user types, wherein the list of modality types and the list of end user types are indexed in an identification database accessible to the dialog identifier device via the network connector;
a context identifier device, wherein the context identifier device assigns an at least one context to (1) the at least one multimodal dialog and to (2) the at least one end user by correlating the multimodal dialog among a first list of contexts and correlating the at least one end user among a second list of contexts, wherein the first list of contexts and the second list of contexts are indexed in a context database accessible to the context identifier device via the network connector;
a relevance classifier device, wherein the relevance classifier device creates a relevance discovery report based on the at least one identification and the at least one context by assigning a one or more weighted intents to (1) the at least one identification and to (2) the at least context based on correlating the at least one identification against a list of all supported identifications and correlating the at least one context against a list of all supported contexts, wherein the list of all supported identifications and the list of all supported contexts are indexed in a relevance database accessible to the relevance classifier device via the network connector;
a connected worker identifier device, wherein the connected worker identifier device parses the relevance discovery report to create a list of the at least one connected worker most responsive to (1) the at least one multimodal dialog and to (2) the at least one end user by correlating the one or more weighted intents against a list of the one or more connected workers indexed in a connected worker database accessible to the connected worker identifier device via the network connector, whereby the list of the one or more connected workers further comprises each of the one or more connected workers listed having (1) an associated identifier, (2) an at least one availability marker, (3) an at least one skill, and (4) an at least one skill ranking;
whereby the list of the one or more connected workers most responsive to the multimodal dialog is prioritized by (1) the at least one availability marker, (2) the at least one skill, and (₃) the at least one skill ranking;
a connected worker router, wherein the connected worker router interprets the list of the one or more connected workers most responsive to the multimodal dialog and the connected worker router directs the at least one multimodal dialog to the one or more connected workers in a prioritized order;
a memory, wherein the memory is coupled to the dialog identifier device, the context identifier device, the relevance classifier device, the connected worker identifier device, and the connected worker router device via the network connector, wherein the memory stores and couples the identification database, the context database, the relevance database, and the connected worker database; and
a controller, further comprising:
an operating system, wherein the operating system directs and controls the operation and function of the dialog identifier device, the context identifier device, the relevance classifier device, the connected worker identifier device, the connected worker router device, and
an input/output module, wherein the input/output module provides basic control and input/output operations to the presence availability discovery device via the network connector.

16. The system of claim 15, wherein the list of modality types further comprises voice, chat, short messaging, multimedia messaging, video, document sharing, form submissions, and review form.

17. The system of claim 15, wherein the list of end user types further comprises human and artificial intelligence, as end user types.

18. The system of claim 15, wherein the list of end user types further comprises human, artificial intelligence, a job title, and an at least one skill, as end user types.

19. The system of claim 15, wherein the list of content types of multimodal dialogs further comprises an at least one metadata associated with the content types of multimodal dialogs.

20. The system of claim 15, wherein the one or more weighted intents further comprises at least one matrix of intents weighted based on use of at least one keyword within a content of the at least one multimodal dialog.

21. The system of claim 15, wherein the at least one availability marker is manually activated by the one or more connected worker, further comprising: available, not available, and do not disturb except for whitelist.

22. The system of claim 15, further comprising an availability channel monitor which monitors the one or more connected workers presence within a set of communication channels and selects the at least one availability marker listed in the list of the one or more connected workers based on the one or more connected workers presence within the set of communication channels.

23. The system of claim 15, wherein the at least one availability marker is determined based on an activation of a sensor within an object associated with the one or more connected workers.

24. The system of claim 15, wherein the at least one availability marker is determined based on a geolocation activation within a satellite-based radio navigation system.

25. The system of claim 15, wherein the at least one skill is determined dynamically based on an artificial intelligence system monitoring the at least one dialog and parsing its content and assigning the at least one skill to the at least one connected workers based on the parsing.

26. The system of claim 15, wherein the at least one skill ranking is determined dynamically based on an artificial intelligence system monitoring the at least one dialog and parsing its content and assigning the at least one skill ranking to the at least one connected workers based on the parsing.

27. The system of claim 15, wherein the list of the one or more connected workers most responsive to the multimodal dialog is prioritized with the highest priority weight given to the at least one availability marker.

28. The system of claim 15, wherein the connected worker router directs the at least one multimodal dialog to the one or more connected workers with the highest priority weight given to the at least one availability marker.
